(19) United States
(12) Patent Application Publication
(10) Pub. No.: US 2010/0130806 A1
(43) Pub. Date: May 27, 2010

(54) Method of treating asbestos-containing waste material

(75) Inventors: Hiroyuki Sakakibara, Tokyo (JP); Mikio Wakasugi, Tokyo (JP); Yasumichi Kanesaki, Tokyo (JP); Takashi Matsuda, Tokyo (JP); Kensuke Kanai, Tokyo (JP)

Correspondence Address: CHAPMAN AND CUTLER, 111 WEST MONROE STREET, CHICAGO, IL, 60603, US

(73) Assignee: Sumitomo Osaka Cement Co., Tokyo (JP)

(21) Appl. No.: 12/312,005

(22) PCT Filed: Oct. 23, 2007
(86) PCT No.: PCT/JP2007/070594

§ 371 Date: Feb. 1, 2010

(30) Foreign Application Priority Data
Oct. 23, 2006 (JP) 2006 288001
Oct. 23, 2006 (JP) 2006 288002
Oct. 23, 2006 (JP) 2006 288003
Oct. 23, 2006 (JP) 2006 288004
Oct. 23, 2006 (JP) 2006 288005
Mar. 30, 2007 (JP) 2007 094326
May 30, 2007 (JP) 2007 143748
Jul. 27, 2007 (JP) 2007 195474

(51) Int. Cl. A62D 3/36; B09B 3/00

(52) U.S. Cl. 588/318

(57) ABSTRACT

A method of asbestos treatment in which an asbestos-containing waste material of arbitrary configuration can be detoxified completely and safely. The method of asbestos treatment comprises impregnating an asbestos-containing waste material with an acid so as to cause at least the asbestos at the surface of the waste material to be nonasbestous and further treating the treatment product in a cement production plant. In particular, the treatment in a cement production plant is a fusion treatment by means of a cement kiln. Therefore, not only can the asbestos-containing waste material be detoxified completely and safely but also a cement reusing the waste material can be produced.

### TECHNICAL FIELD

The present invention relates to a method of treating an asbestos-containing waste material, and in particular, to a method of treating asbestos-containing waste material in which an asbestos-containing waste material can be treated completely and safely.

### BACKGROUND ART

Asbestos prevents strength from lowering over a long period of time and is excellent in fire resistance, and therefore, has been used widely in various fields, and thus, has been used in many conventional members in various fields, such as slate boards, water pipes, fire resistant coating materials, break pads, gaskets, heat insulating plates, ropes, packing materials and fillers for acetylene tanks.

In recent years, however, it has become clear that asbestos causes health problems in many ways, such as asbestos lung, lung cancer and malignant mesothelioma, and the use thereof has been banned.

In particular, many slate members and fire resistant coating materials have been used as members containing asbestos, and these slate members and the like are used for many ceilings, wall materials and the like.

A large amount of asbestos-containing members that have been used in this manner are dangerous to the environment when the use thereof is continued because of the above described environmental reasons, and therefore, the situation has become such that they must be treated immediately so as to be detoxified and disposed of.

Though asbestos-containing members, such as slate members, which have been mass produced so far are handled as general waste materials and are disposed of as an industrial waste material, the dispersing and scattering of asbestos have become a problem, and an urgent safety measure has been demanded.

In particular, the tearing down of buildings using asbestos-containing building materials, such as fire resistant coating materials and ceiling plates, is at its peak, and therefore, such problems as finding and treating asbestos have become very serious.

Asbestos is naturally produced mineral fibers and includes serpentinite based chrysotile (3MgO.2SiO₂.2H₂O), amphibole based amosite ((Mg, Fe)₇Si₈O₂₂(OH)₂), crocidolite (Na₂Fe₃²⁺Fe₂³⁺Si₈O₂₂(OH)₂), anthophyllite (Mg₇Si₈O₂₂(OH)₂), toremolite (Ca₂Mg₅Si₈O₂₂(OH)₂) and actinolite (Ca₂(Mg, Fe)₅Si₈O₂₂(OH)₂).

Though it is known that serpentinite based chrysotile dehydrates and transforms at approximately 700° C. and changes to harmless forestlite (2MgO.SiO₂) at approximately 900° C. when heated, it is difficult in practice to detoxify it, and therefore, these properties are not sufficiently and effectively used.

The danger of asbestos originates from it being fibrous.

Accordingly, Japanese Patent No. 3680958 (Patent Document 1) describes a cement production method using a rotary kiln characterized in that asbestos waste material is supplied into a rotary kiln from the vicinity of a burning means provided on the exhaust opening side of the above described rotary kiln so that the supplied asbestos waste material and a cement material are treated by the above described burning means as a method for detoxifying asbestos through the modification or fusion of fibers.

In addition, Japanese Unexamined Patent Publication 2005-279589 (Patent Document 2) describes a method of treating a slate waste material characterized in that a slate waste material containing asbestos is immersed in a solution of a fusion agent made of a mixture of borax, boric acid and sodium carbonate or a mixture of borax and sodium carbonate without being broken and put under reduced pressure so that voids inside the slate are impregnated with the fusion agent that penetrates from the surface of the slate waste material as a preprocess, and after that, the preprocessed slate waste material is immersed in a fusion agent with which a fusion furnace is filled in, which is then heated to a temperature in a range from 780° C. to 1000° C., and thus, asbestos in the slate waste material is fused and converted to glass.

Furthermore, Japanese Unexamined Patent Publication 2006-52177 (Patent Document 3) describes a method of treating inorganic substance based waste material in which an inorganic substance based waste material is put into a kiln for cement production together with a material for cement production so as to be converted to cement through heat treatment and which is characterized in that the size of the waste material is adjusted so that the minimum value is 1 mm or greater, the maximum value is 1/10 or less of the inner diameter of the kiln for cement production, and the shortest distance to the surface from any location inside the waste material is 30 mm or less, and the ratio of the waste material occupied in the total mass of the waste material and the cement material is in a range from 1% to 20% in a dry state, the waste material is put into the kiln for cement production together with the material for cement production through the bottom of the kiln, heat treatment is carried out for 20 seconds to 60 seconds at 1000° C. to 1500° C. so that a sintered body is gained, and the gained sintered body is converted to a powder.

The conventional methods described in the above patent documents are methods of detoxification in which an asbestos-containing waste material is put into a fusion furnace or a cement kiln.

However, asbestos cannot be prevented from dispersing or scattering when an asbestos-containing waste material is supplied to a fusion furnace or a cement kiln. In addition, according to the above described conventional methods, a mechanical means must be mainly used in such a manner that the asbestos-containing waste material is broken using heavy machinery in order to crush, decompose or microscopically crack the asbestos-containing waste material in the preprocess, which ends up dispersing and scattering the asbestos, and thus, the problem where the health of the human body is affected during the supply process to the fusion furnace or the cement kiln is not sufficiently solved.

Patent Document 1: Japanese Patent No. 3680958

Patent Document 2: Japanese Unexamined Patent Publication 2005-279589

Patent Document 3: Japanese Unexamined Patent Publication 2006-52177

### DISCLOSURE OF THE INVENTION

### Problem To Be Solved By the Invention

An object of the present invention is to provide a method of treating an asbestos-containing waste material in which an asbestos-containing waste material of arbitrary configuration can be detoxified completely and safely irrelevant of the size and hardness.

In particular, in the case where the asbestos-containing waste material is a slate board, the present invention provides a method of treating an asbestos-containing waste material in which an asbestos-containing waste material can be detoxified completely and safely in a short period of time compared to the prior art in which a high temperature treatment over a long period of time is required, and the efficiency of detoxification is poor.

In addition, a method of treating an asbestos-containing waste material in which an asbestos-containing waste material can be reused as a cement clinker or a material for the production of cement is provided.

### Means For Solving Problem

The present inventors found that an asbestos-containing waste material can be treated with an acid, and subsequently, the treatment can be carried out in two stages in a cement plant so that an asbestos-containing waste material of arbitrary configuration, for example, cotton form, plate form, powder form and broken piece form, can be detoxified completely and safely, and thus, achieved the present invention.

The method of treating an asbestos-containing waste material according to claim 1 is a method of treating an asbestos-containing waste material, characterized in that an asbestos-containing waste material is impregnated with an acid so as to cause the asbestos in the above described waste material to be non-asbestos, and further treating the treated product in a cement production plant.

In addition, the method of treating an asbestos-containing waste material according to claim 2 is the method of treating an asbestos-containing waste material according to claim 1, characterized in that the treatment in the above described cement production plant is fusion treatment using a cement kiln.

The method of treating an asbestos-containing waste material according to claim 3 is the method of treating an asbestos-containing waste material according to claim 2, characterized in that the asbestos-containing waste material is a slate board, the above described cement kiln is a rotary cement kiln and the above described treated, non-asbestos product is supplied from the bottom of the cement rotary kiln.

The method of treating an asbestos-containing waste material according to claim 4 is the method of treating an asbestos-containing waste material according to claim 2 or 3, characterized in that the above described treated, non-asbestos product is supplied to the cement kiln without being crushed.

Thus, two-stage treatment: acid treatment and fusion treatment, is provided, and asbestos members of any sort can be detoxified safely and completely without requiring a preprocess, such as crushing.

In particular, an asbestos member is made non-asbestos through acid treatment before being subjected to fusion treatment, and thus, asbestos can be prevented from dispersing and scattering, and handling is safe, and the detrimental effects on the health can be reduced a great deal.

The method of treating an asbestos-containing waste material according to claim 5 is the method of treating an asbestos-containing waste material according to any of claims 1 to 3, characterized in that crushing and pulverizing treatment is carried out on the asbestos-containing waste material in an airtight state when the asbestos-containing waste material is impregnated with an acid.

The method of treating an asbestos-containing waste material according to claim 6 is the method of treating an asbestos-containing waste material according to claim 5, characterized in that the above described airtight state is a state where the asbestos-containing waste material is immersed in an acid.

The method of treating an asbestos-containing waste material according to claim 7 is the method of treating an asbestos-containing waste material according to claim 5, characterized in that the above described airtight state is a state where crushing and pulverizing are carried out using a crusher and pulverizer having an airtight case, and transportation from the crusher and pulverizer to an acid treatment container is possible with an airtight case, and crushing and pulverizing are carried out using an acid treatment container with an airtight case.

Thus, the steps of carrying out crushing and pulverizing treatment, acid treatment and fusion treatment on an asbestos-containing waste material in an airtight state are provided in an environmentally safe manner, and, asbestos-containing waste-materials of any sort, including large asbestos-containing waste materials, can be detoxified effectively, safely and completely.

In particular, treated, non-asbestos products are subjected to fusion treatment in a cement kiln after the asbestos-containing material is crushed and pulverized in an airtight state and carrying out acid treatment, and therefore, asbestos can be prevented from dispersing and scattering, and handling is safe, and the detrimental effects on the health can be reduced a great deal.

The method of treating an asbestos-containing waste material according to claim 8 is the method of treating an asbestos-containing waste material according to claim 2, characterized in that the above described asbestos-containing waste material is an asbestos-sprayed waste material, and the treatment in the cement plant is to supply the treated, non-asbestos product either in the step of putting a material in a cement clinker sintering plant or in the step of supplying a material to a cement kiln and carry out fusion treatment in a cement kiln.

Thus, asbestos-sprayed waste material is selected by excluding waste material having a relatively high density, and acid thoroughly penetrates the waste material, which is then completely detoxified, and thus, asbestos can be prevented from dispersing and scattering and causing any problems, and asbestos-containing waste material can be safely and completely detoxified without requiring a preprocess, such as crushing, whatever asbestos-containing material is supplied in the step of putting a material in a cement clinker sintering plant or the step of supplying a material to a cement kiln.

The method of treating an asbestos-containing waste material according to claim 9 is the method of treating an asbestos-containing waste material according to any of claims 2 to 8, characterized in that the acid is an acid solution containing a compound including fluorine and a mineral acid, the treated, non-asbestos product is a precipitate resulting from neutralization of the solution after asbestos treating the asbestos-containing waste material with alkali, and the precipitate is mixed as a material at the time of production of a cement clinker containing calcium fluoroaluminate, and thus, fusion treatment is carried out in the above described cement kiln.

The method of treating an asbestos-containing waste material according to claim 10 is the method of treating an asbestos-containing waste material according to claim 9, characterized in that the precipitate contains calcium fluoride, aluminum hydroxide, iron hydroxide, magnesium hydroxide and a silicate compound.

Thus, asbestos-containing waste material is treated in a treatment liquid containing a compound including fluorine and a mineral acid, so that detoxification treatment can be carried out on the asbestos, and at the same time, it becomes possible to effectively use the calcium fluorine ions and metal ions, such as Al and Fe, included in the treated waste after the detoxification treatment as the material for a cement clinker containing calcium fluoroaluminate.

The method of treating an asbestos-containing waste material according to claim 11 is the method of treating an asbestos-containing waste material according to any of claims 2 to 10, characterized in that the above described treated, non-asbestos product is supplied to the cement kiln together with a flux.

The method of treating an asbestos-containing waste material according to claim 12 is the method of treating an asbestos-containing waste material according to claim 1, characterized in that the above described cement production plant is a crushing plant in a cement finishing step, where the treated, non-asbestos product is mixed as a plaster source at the time of cement production.

The method of treating an asbestos-containing waste material according to claim 13 is the method of treating an asbestos-containing waste material according to claim 12, characterized in that the treated, non-asbestos product is gained by making the asbestos contained in the above described waste material non-asbestos by impregnating the waste material containing asbestos and plaster with an acid.

Thus, waste material containing asbestos and plaster can be detoxified safely through acid treatment in an environmentally safe manner, and at the same time, the detoxified, treated product can be used effectively as a plaster source, and therefore, more effective use can be made of waste material containing asbestos and plaster with low energy consumption.

The method of treating an asbestos-containing waste material according to claim 14 is the method of treating an asbestos-containing waste material according to claim 12, characterized in that the above described treated, non-asbestos product is the asbestos contained in the above described waste material, which is made non-asbestos by impregnating the waste material containing asbestos and calcium with sulfuric acid, and a plaster resulting from the reaction between the contained calcium and sulfuric acid.

Thus, sulfuric acid treatment can be carried out on waste material containing asbestos and calcium so that the asbestos is detoxified completely in an environmentally safe manner, and at the same time, the calcium contained in the waste material reacts with sulfuric acid, so that a plaster is created, and thus, the detoxified, treated product can be used effectively as a plaster source for the production of cement with low energy consumption.

Accordingly, effective use can be made of waste material containing asbestos and calcium.

The method of treating an asbestos-containing waste material according to claim 15 is the method of treating an asbestos-containing waste material according to claim 12, characterized in that the treated, non-asbestos product is a solid gained through the first step of fusing the waste material containing asbestos with a first acid for generating a water soluble salt through reaction with calcium or magnesium, the second step of depositing calcium sulfate by making the liquid treated in the first step make contact with sulfuric acid, and the third step of separating a solid from the liquid treated in the second step.

The method of treating an asbestos-containing waste material according to claim 16 is the method of treating an asbestos-containing waste material according to any of claims 12 to 15, characterized in that the above described waste material is a sprayed material on the rubble when a building is torn down.

The method of treating an asbestos-containing waste material according to claim 17 is the method of treating an asbestos-containing waste material according to any of claims 1 to 13, 15 and 16, characterized in that the acid is one or more selected from the group consisting of phosphoric acid, sulfuric acid, nitric acid, hydrochloric acid and fluoric acid.

In particular, the above described acid in the method of treating an asbestos-containing waste material according to claim 9 is a mineral acid, and the above described acid in the method of treating an asbestos-containing waste material according to claim 15 is the first acid, excluding those with which a water-insoluble salt is produced.

The method of treating an asbestos-containing waste material according to claim 18 is the method of treating an asbestos-containing waste material according to claim 17, characterized in that the acid is an acid solution to which at least one fluoride selected from the group consisting of fluorides of alkali metals, alkali earth metals and ammonium, and hydrofluoric acid, and at least one mineral acid selected from the group consisting of hydrochloric acid, sulfuric acid and nitric acid are added, so that the pH of the gained acid solution is 1 or less.

The method of treating an asbestos-containing waste material according to claim 19 is the treatment method of detoxifying an asbestos-containing waste material according to claim 18, characterized in that the above described fluoride is added so that the ion concentration of the fluoride in the acid solution in the case where the entirety of the ion source is dissociated is 1:5 weight % to 10 weight %.

The method of treating an asbestos-containing waste material according to claim 20 is the treatment method of detoxifying an asbestos-containing waste material according to claim 18 or 19, characterized in that the weight ratio of the acid solution in the asbestos-containing waste material is 3 to 100 in the mixture.

When these treatment methods are provided, the needle-like structures of asbestos are broken, so that asbestos is converted to a non-asbestos material, and thus, detoxification treatment is carried out.

Accordingly, asbestos-containing waste materials which are treated as such can be handled as detoxified, treated products safe for handling.

### Effects of the Invention

The method of treating an asbestos-containing waste material according to the present invention allows detoxification treatment to be carried out on asbestos-containing waste materials safely and completely.

In particular, treatment can be carried out using a cement production plant, so that the materials can be used for the production of cement clinkers and cement, and thus, it becomes possible to make effective use of asbestos-containing waste materials.

In addition, various waste materials, such as slate boards and sprayed materials, can be treated completely and safely, irrespectively of the size of the asbestos-containing waste material and the properties, for example the hardness.

### BRIEF DESCRIPTION OF THE DRAWINGS

FIG. 1 is a diagram schematically showing the steps in the production of cement; and

FIG. 2 is a diagram schematically showing the finishing steps in the production of cement.

### EXPLANATION OF SYMBOLS

1 hopper into which material is put

2 material storage

3 material crusher

4 blending silo

5 material storage silo

6 preheater

7 furnace for temporary burning

8 cement rotary kiln

9 cooler

1′ cement clinker silo

2′ plaster yard

3′ preparatory crusher

4′ cement crusher

5′ separator

6′ mixer

7′, 8′ cement silos

### BEST MODE FOR CARRYING OUT THE INVENTION

In the following, preferred embodiments of the present invention are described, but the invention is not limited to these.

The method of treating asbestos according to the present invention is a method of treating an asbestos-containing waste material in which an asbestos-containing waste material is impregnated with an acid and the treated, non-asbestos product originating from the asbestos in the above described waste material is further treated in a cement production plant.

The treatment in the cement production plant includes fusion treatment using a cement kiln and treatment in a crushing plant in the finishing step for cement.

Thus, acid treatment and treatment in a cement plant are provided, so that asbestos members of any sort can be detoxified safely and completely.

In particular, in the case where fusion treatment is carried out in a cement kiln, the asbestos member is made non-asbestos through acid treatment before being subjected to treatment in a cement production plant, preferably before being subjected to fusion treatment using a cement kiln or, more preferably, using a rotary cement kiln, so that the asbestos can be prevented from dispersing and scattering and handled safely, and thus, detrimental effects on the health can be reduced a great deal.

The type and form of asbestos-containing waste materials to which the method of treating an asbestos-containing waste material according to the present invention can be applied are not particularly limited, and all waste materials when buildings containing asbestos, for example cement-based or plaster-based asbestos-sprayed members and slate boards, are torn down, particularly all waste materials once used as building materials apply.

In particular, waste materials that can be expected to come out in large amounts when buildings having asbestos-sprayed members are torn down and cause problems with dispersing and scattering asbestos can be used effectively.

Waste materials containing asbestos and plaster once used as building materials, for example plaster boards containing asbestos and asbestos-sprayed plaster, also apply.

Furthermore, waste materials containing asbestos and calcium, for example asbestos-containing cement-based boards and asbestos-containing cement-sprayed members, also apply.

Here, calcium contained in waste materials includes compounds that function as a calcium source, such as calcium oxide, calcium hydroxide, minerals included in cement, such as alite, belite, calcium aluminate and ferrite, and hydrates of these, in addition to calcium itself.

In addition, collected asbestos-containing slate boards include organic additives, such as paper fibers and: glues which can be easily separated by filtering the residue after acid treatment, while collected plaster boards include organic additives, such as paper fibers and glues which can be easily separated in the below described process for acid treatment, for example.

In the method of treating an asbestos-containing waste material according to the present invention, first acid treatment is carried out on an asbestos-containing waste material. Concretely, the asbestos-containing waste material is impregnated with an acid.

A method of making asbestos non-asbestos by spraying an asbestos-containing building at a demolition site with acid before tearing it down and a method of immersing waste materials in acid after an asbestos-containing building at a demolition site is torn down can be cited as examples.

In terms of acids that can be used, phosphoric acid, sulfuric acid, nitric acid, hydrochloric acid, fluoric acid and mixed acids of these are effective, and though the concentration of these is not particularly limited, as long as it meets such conditions that the reaction for making asbestos non-asbestos can be induced, detoxification treatment can be carried out on a greater amount in a shorter period of time when the concentration is high.

In addition, an appropriate concentration can be set for the acid in accordance with the situation at the demolition site.

The acid treatment makes the asbestos in the above described asbestos-containing waste materials non-asbestos. Even in the case where the asbestos-containing waste material is dense, the inside is wet with acid, and thus, the asbestos does not disperse.

Here, non-asbestos is the state after needle-like crystal, such as chrysotile, crocidolite and amosite, is converted to another substance through reaction between asbestos and an acid. In such a state, asbestos is harmless to the human body.

In particular, it is desirable for the acid treatment to make asbestos-containing waste material non-asbestos using an acid solution containing a compound including fluorine and a mineral acid.

As the mineral acid, any water-soluble mineral acid, such as phosphoric acid, hydrochloric acid, sulfuric acid and nitric acid, can be used. In particular, mineral acids, such as hydrochloric acid, sulfuric acid and nitric acid, and mixed acids of these, preferably at least one mineral acid selected from the group consisting of hydrochloric acid, sulfuric acid and nitric acid, is used. The acid must be able to dissolve cement-based binders having a high pH included in asbestos-containing waste materials, and be appropriate for use.

It is desirable for the acid to be an acid solution to which at least one fluoride selected from the group consisting of fluoride salts of alkali metals, alkali earth metals and ammonia, and hydrofluoric acid, and at least one mineral acid selected from the group consisting of hydrochloric acid, sulfuric acid and nitric acid are added, so that the pH of the gained acid solution is 1 or lower.

Here, as the mineral acid, any water-soluble mineral acid other than phosphoric acid can be used, and in particular, such mineral acids as hydrochloric acid, hydrofluoric acid and nitric acid, and mixed acids of these, are appropriate for use for dissolving cement-based binders having a high pH included in waste materials.

Though the concentration of the mineral acid is not particularly limited, it is desirable for the acid to be mixed with a compound containing chloride, so that the pH of the gained acid solution is 1 or lower.

This is because it is possible to dissolve cement-based binders having a high pH included in the asbestos-containing waste material in a shorter period of time in the case where the pH of the gained acid solution is 1 or lower.

In addition, it is preferable to keep the pH of the treatment liquid at 1 or lower at all times, including when treatment is being carried out to make the asbestos in asbestos-containing waste material non-asbestos using an acid solution, that it so say, when the asbestos-containing waste material is made to make contact with an acid solution through immersion, in order to shorten the time for dissolving cement based binders having a high pH included in the waste material, and this can be achieved by adding a mineral acid to be contained in the acid solution during the treatment for making the asbestos-containing waste material non-asbestos whenever necessary.

In addition, the compound containing fluorine included in the acid solution is not particularly limited, as long as it is a water-soluble compound, and at least one water-soluble compound including chlorine is selected from among the group consisting of fluoride salts of alkali metals, alkali earth metals and ammonia, tetrafluoroborate, hexafluorosilicate and hydrofluoric acid, for example. Preferably at least one water-soluble compound including fluorine is selected from the group consisting of fluoride salts of alkali metals, alkali earth metals and ammonia, and hydrofluoric acid.

Fluorides and difluorides of alkali metals, alkali earth metals and ammonia, as well as mixtures of these, can be cited as examples of fluoride salts.

Fluorides which are particularly appropriate for use are ammonium fluoride and hydrofluoric acid.

When the acid solution contains a compound including fluorine, the SiO₂ skeleton of the asbestos can be broken.

Such an amount of the compound including fluorine is added that the concentration of fluoride ions in the acid solution becomes 1.5 weight % to 10 weight %, preferably 2.5 weight % to 7 weight % in the case where all of the compound including fluorine, that is, the ion source, is supposed to be dissolved.

When such an amount of the compound including fluorine is added, such working effects can be gained that the SiO₂ skeleton of the asbestos can be dissolved more efficiently.

When the asbestos-containing waste material is made to make contact with the acid solution, concretely, when the asbestos-containing waste material is immersed in the acid solution and left still or stirred, the asbestos in the asbestos-containing waste material and the acid solution make effective contact, so that the asbestos becomes non-asbestos.

At this time, it is preferable for the pH of the acid solution to be kept at 1 or lower, as described above, and a method for adding an appropriate amount of mineral acid to be contained in the acid solution during the above described treatment for detoxification so that the pH is kept at 1 or lower can be cited as an example of the method for keeping the pH as such.

In particular, an appropriate ratio can be set for the acid solution to the asbestos-containing waste material in the mixture during the treatment for making the asbestos non-asbestos, in accordance with the amount of asbestos contained in the asbestos-containing waste material and the amount of the cement-based binder, and it is desirable for the weight ratio to be 3 to 100, preferably 5 to 20.

When the weight ratio is within the above described range, the pH of the solution can be prevented from further rising, due to the reaction between the mineral acid and the cement-based binder, so that it becomes possible to further shorten the time for treatment, thus making the efficiency of treatment higher, and the cost for treatment of waste after the treatment for making asbestos non-asbestos can be reduced.

Thus, when a preferable acid solution having a pH of 1 or lower and a fluorine ion concentration in a specific range is used, treatment for making asbestos-containing waste materials of any sort non-asbestos can be carried out easily and thoroughly in a short period of time while effectively preventing asbestos dust and the like from dispersing and scattering, so that the above described Ministry of Health, Labor and Welfare standard of 0.1 weight % or less can be met.

In accordance with methods of treatment for making asbestos non-asbestos having only the step for acid treatment of an asbestos-containing waste material, it is difficult for the acid to penetrate through asbestos-containing waste materials having a relatively high density and a large size, for example, and in some cases it is difficult to thoroughly detoxify the waste material in practice.

In contrast, when carrying out a preprocess for impregnating the waste material with acid before acid treatment in the step of providing cracks in the waste material or the step for pulverization and crushing, for example, a new problem arises, such that the asbestos disperses and scatters.

According to the method of the present invention, however, the treated, non-asbestos product after carrying out acid treatment on an asbestos-containing waste material of a relatively large size, for example, is in a damp state on the inside at the stage of acid treatment, even in the case where the waste material cracks or chips during the subsequent work of treatment, for example conveyance and supply to a fusion furnace, and therefore, there aren't any problems with the asbestos, such as scattering and dispersing of asbestos.

In particular, in the case where the asbestos-containing waste material is an asbestos-sprayed material, acid penetrates the waste material thoroughly, so that the asbestos can be completely detoxified.

Accordingly, after the above described step for acid treatment, measures can be taken against acid residue and eluate, so that detoxification treatment can be carried out thoroughly and safely.

In particular, in the case where a waste material including asbestos and calcium is treated in a pulverizing plant during the finishing steps for cement, it is desirable to use sulfuric acid for acid treatment.

When asbestos- and calcium-containing waste materials are sufficiently immersed in sulfuric acid, the asbestos is made non-asbestos, and at the same time, the calcium included in the waste material reacts with the sulfuric acid, so that plaster is created, and therefore, the asbestos- and calcium-containing waste material can be used as a plaster source, which is a cement material.

It is particularly desirable for the acid treatment to have a first step of dissolving an asbestos-containing waste material in a first acid which generates a water-soluble salt when it reacts with calcium or magnesium, a second step of depositing a water-insoluble salt by making the treatment liquid in the first step make contact with a second acid which generates a water-insoluble salt when it reacts with calcium, and a third step of separating a solid from the waste left over from the second step.

In the first step, calcium and magnesium in the asbestos are dissolved, so that the structure is destroyed and the asbestos is treated and made non-asbestos. Accordingly, waste materials containing asbestos on which treatment is carried out can be handled safely as treated, non-asbestos products.

Treatment agents containing an inorganic acid can be used as the first acid, and at least one selected from among hydrochloric acid, fluoric acid, phosphoric acid and nitric acid is appropriate for use as the inorganic acid. In addition, it is preferable for the treatment agent to further include a fluorine-containing compound, and at least one elected from among fluorides, silicofluorides and borofluorides is appropriate for use as the fluorine-containing compound.

Next, in the second step, a second acid which generates a water-insoluble salt when it reacts with calcium is made to make contact with the treatment liquid left over from the first step, so that a water-insoluble salt deposits. Concretely, sulfuric acid is used as the second acid, and thus, it becomes possible to deposit mainly calcium sulfate.

In the third step, a solid is separated from the waste left over from the second step. The separated residue is a byproduct of calcium sulfate which contains a large amount of calcium sulfate and can be used as a plaster source when cement is produced.

Though the concentration of the acid added in the respective treatment steps is not particularly limited, the concentration of the first acid may satisfy- the conditions for inducing a reaction for making asbestos non-asbestos, for example, and a high concentration generally allows the treatment to make a greater amount of asbestos non-asbestos in a shorter period of time. In addition, the second acid may have such a concentration that calcium sulfate deposits, and an appropriate concentration may be set in accordance with the specifics of the demolition site in the case where sulfuric acid is used.

The concentration of hydrogen ions in the first acid, which is added in the first step, is approximately 3 mol/L, for example, and the concentration of hydrogen ions in the treatment liquid is approximately 10⁻⁴ mol/L at the point in time when asbestos is treated in the first step. In addition, the concentration of hydrogen ions inn the treatment liquid that is to be filtered in the third step recovers to approximately 1.6 mol/L when sulfuric acid is added in the second step. Therefore, it becomes possible to reduce the amount of acid consumed in the method of treatment for detoxifying asbestos, by reusing the filtered treatment liquid as the first acid.

Here, it is desirable to crush and pulverize the asbestos-containing waste material in an airtight state before and during the above described acid treatment.

Thus, such steps are provided that crushing and pulverizing treatment, acid treatment and treatment in a cement production plant, such as in a cement kiln, preferably in a rotary cement kiln and preferably fusion treatment, are carried out on an asbestos-containing waste material in an environmentally safe manner, and thus, asbestos-containing waste materials of any sort, including asbestos-containing waste materials of a large size, can be detoxified effectively, safely and thoroughly.

In particular, the treated, non-asbestos product after crushing, pulverizing and acid treatment is carried out on an asbestos-containing waste material in an airtight state is subjected to fusion treatment in a cement kiln, preferably a rotary cement kiln, and therefore, handling is safe, and the asbestos does not disperse or scatter, so that the detrimental effects on the health can be reduced a great deal.

Here, the airtight state is a state where asbestos does not make direct contact with the air in the work environment (excluding the air within the airtight space), and a state where crushing and pulverizing are carried out using a crusher and pulverizer having an airtight case, and transportation from the crusher and pulverizer to an acid treatment container is possible with an airtight case, and crushing and pulverizing are carried out using an acid treatment container with an airtight case can be cited as an example.

Thus, an asbestos-containing waste material is pulverized and crushed, and it is easy to turn asbestos into a treated, non-asbestos product through acid treatment, and it becomes possible to make asbestos non-asbestos in a short period of time.

Particularly when acid treatment is carried out on an asbestos-containing waste material, preferably an asbestos-containing waste material is immersed in the above described first acid and crushing and pulverizing treatment is carried out at the same time, the step of crushing and pulverizing waste material in such a manner that the asbestos does not disperse or scatter and the step for acid treatment for converting the asbestos-containing waste material to a treated, non-asbestos product can be carried out simultaneously and appropriately.

In addition, it is sufficient for the asbestos-containing waste material to become of a damp state due to at least acid, and therefore, the asbestos-containing waste material can be crushed and pulverized in such a state as to be immersed in acid, as described above, and the asbestos-containing waste material can be taken out from the acid and the asbestos-containing material crushed and pulverized in a damp state after being immersed in acid.

In addition, other methods for crushing and pulverizing an asbestos-containing waste material in an airtight state include methods for crushing and pulverizing an asbestos-containing waste material in a state where crushing and pulverizing are carried out using a crusher and pulverizer having an airtight case, and transportation from the crusher and pulverizer to an acid treatment container is possible with an airtight case, and crushing and pulverizing are carried out using an acid treatment container with an airtight case.

As the method, a method providing a crusher, a pulverizer, a transportation means and an acid treatment container, and covering these units with one airtight case, and a method providing a crusher, a pulverizer, a transportation means and an acid treatment container in such a formation as to be sealable airtight and connecting the units with an airtight connection can be cited.

As the means for crushing and pulverizing the asbestos-containing waste material, means for crushing and pulverizing publicly known waste building materials can be used.

In particular, individual units in such a formation as to be sealable airtight, impact crushers, hammer crushers, ball mills, standing mills and tower mills can be cited.

Thus, asbestos-containing waste materials of a large size, for example slate boards, can be easily and thoroughly made non-asbestos using acid.

Here, in accordance with the eh treatment method for making asbestos non-asbestos through only the step for acid treatment, without crushing or pulverizing the asbestos-containing waste material, it is sometimes difficult to thoroughly detoxify the waste material in practice, because it is difficult for acid to penetrate through highly dense asbestos-containing waste materials, for example.

However, crushing and pulverizing treatment can be safely carried out on treated, non-asbestos products after carrying out crushing, pulverization and acid treatment on an asbestos-containing waste material in an airtight state, and the waste material can be thoroughly detoxified through acid treatment after crushing and pulverization, and thus, there are no problems, such as asbestos dispersing and scattering during the work of treatment, for example the subsequent transportation and supply to a fusion furnace in practice.

Accordingly, detoxification treatment can be carried out thoroughly and safely by taking measures against acid residue and eluate after the above described step for acid treatment.

Examples of the treatment for making asbestos-containing waste materials non-asbestos through acid treatment according to the present invention are given in the following. In Example 2, an asbestos-containing waste material is crushed and pulverized in an airtight state before acid treatment.

Here, the fluoride ion concentration is the value in the case where 100% of the added fluoride dissociates, “parts” are weight parts, and “%” is mass percent.

In addition, in the quantitative analysis of asbestos, values are measured in accordance with JIS A 1481: “Method for Measuring Content of Asbestos in Building Material Products,” and the quantitative lower limit value for asbestos in X-ray spectrometry (X′pert pro, made by Spectris Co., Ltd., Panalitical Business Department) used for quantitative analysis are 0.026% for chrysotile, 0.008% for amosite and 0.012% for crocidolite.

### Example 1

20 parts of asbestos reference samples of chrysotile, amosite and crocidolite (reference samples available from Japan Association for Working Environment Measurement were respectively immersed in 95 parts of a 10% hydrochloric acid solution (diluted 35% product made by Kanto Chemical Co., Inc.) and 5 parts of ammonium fluoride (made by Kanto Chemical Co., Inc.) (hydrogen ion concentration: 2.81 mol/L·pH=−0.45, fluoride ion concentration: 27000 mg/L=1.4 mol/L·2.9%) and dissolved in 3 hours at 40° C., and it was found that the ratio of residual asbestos in each case was no higher than the above described quantitative lower limit when measured in accordance with the above described quantitative analysis method.

### Example 2

A cement-based board (slate material) containing 3.4% of chrysotile, 36.2% of amosite and 8.1% of crocidolite was roughly pulverized (maximum particle diameter: approximately 1 cm to 2 cm) using pliers within a glove box with a HEPA filter, and pulverized to a powder in an airtight state using an analysis mill made by IKA GmbH.

20 parts of the above described pulverized cement board (slate material) was immersed in 95 parts of a 10% hydrochloric acid solution (diluted 35% product made by Kanto Chemistry Co., Ltd.) and 5 parts of ammonium fluoride (made by Kanto Chemistry Co., Ltd.) (hydrogen ion concentration: 2.81 mol/L·pH=−0.45, fluoride ion concentration: 27000 mg/L=1.4 mol/L·2.9%) and dissolved in 3 hours at 40° C., and it was found that the ratio of residual asbestos in each case was no higher than the above described quantitative lower limit when measured in accordance with the above described quantitative analysis method.

### Example 3

20 parts of asbestos reference samples of chrysotile, amosite and crocidolite (reference samples available from Japan Association for Working Environment Measurement were respectively immersed in 95 parts of a 10% hydrochloric acid solution (diluted 35% product made by Kanto Chemistry Co., Ltd.) and 5 parts of 46% hydrofluoric acid (made by Kanto Chemistry Co., Ltd.) (hydrogen ion concentration: 2.81 mol/L·pH=−0.45, fluoride ion concentration: 23000 mg/L=1.4 mol/L·2.4%) and dissolved in 3 hours at 40° C., and it was found that the ratio of residual asbestos in each case was no higher than the above described quantitative lower limit when measured in accordance with the above described quantitative analysis method.

Preferably, alkali is added to the treated waste after the treatment for making the asbestos-containing waste material non-asbestos through the above described acid treatment, in order to neutralize the waste and generate precipitate.

Concretely, the asbestos-containing waste material may be immersed in and made to make contact with the above described treatment solution, the treated, detoxified and undissolved part filtered out, alkali added to the filtered liquid so as to neutralize it, and the generated precipitate filtered out and dehydrated, and thus precipitate cake gained, or the asbestos-containing waste material may be immersed in and made to make contact with the above described treatment solution and alkali added so as to neutralize the solution, without filtering out the treated, detoxified and undissolved part, and after that filtered out and dehydrated, and thus precipitate cake gained.

Fluorine ions, ammonium ions, hydrogen ions, chlorine ions, calcium ions, silicate ions, iron ions, aluminum ions, magnesium ions and sulfate ions, for example, are dissolved in the treated waste after treatment for detoxifying the asbestos-containing waste material using the above described treatment solution.

An alkali, for example sodium hydroxide, calcium hydroxide, calcium oxide or calcium carbide, is added to this solution, and thus, a precipitate, for example of calcium fluoride (CaF₂), iron hydroxide (Fe(OH)₃), aluminum hydroxide (Al(OH)₃), magnesium hydroxide (Mg(OH)₂) or a silicate compound, is generated, and the cake including this precipitate can be mixed as a material for the production of a cement clinker. Particularly in the case where an acid solution containing a compound including fluorine and mineral acid is used for acid treatment, the treated waste includes fluorine ions and calcium fluoride precipitates, the cake can be mixed as a material for the production of a cement clinker including calcium fluoroaluminate, that is, a cement clinker that can be used for a quick-dry cement.

Ultra-quick-dry cement can be cited as an example of cement that includes calcium fluoroaluminate.

In order to produce a quick-dry cement including calcium fluoroaluminate, for example jet cement, it is necessary to use fluorite (CaF₂) and bauxite (Al₂O₃) in addition to materials for conventional Portland cement, so that calcium fluoroaluminate 11CaO.7Al₂O₃.CaF₂, which is a quick-dry component, is generated in the cement, and therefore, the cake gained by filtering out and dehydrating the above described precipitate resulting from neutralization can be supplied as a material for a cement clinker.

According to the method of the present invention, the above described treated, non-asbestos product after acid treatment is treated in a cement plant, preferably without being crushed or pulverized, in the case where the asbestos-containing waste material is slate boards, and fusion treatment is carried out in a fusion furnace, preferably in a cement kiln and more preferably in a rotary cement kiln.

As for the fusion treatment in a cement plant, in the case where an asbestos-containing slate material having a size of approximately 50 cm×50 cm is carried to a fusion treatment site from a demolition site after a building is torn down, it is not crushed any further in the fusion treatment site, but undergoes the above described acid treatment and is put in a fusion furnace as it is.

Thus, high-temperature fusion treatment is carried out, so that any asbestos which may remain inside the asbestos-containing waste material after acid treatment can be treated and completely detoxified, and at the same time, the acid and eluate remaining after acid treatment can be treated and reused as a material for a cement clinker.

As the cement kiln, a rotary cement kiln in a cement clinker sintering plant is appropriate for use, and it becomes possible to carry out uniform fusion treatment on a large amount of waste material at once using such a cement kiln, and at the same time, it becomes possible to produce a cement clinker, as well as to effectively recycle asbestos-containing waste materials.

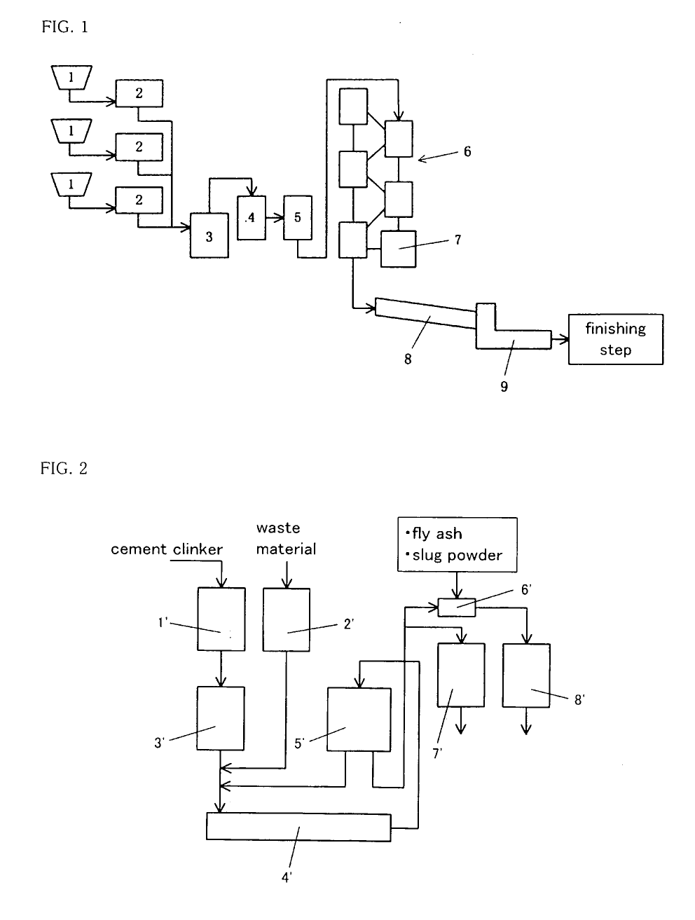

In addition, in the case where the above described treated, non-asbestos product after acid treatment is a product gained by treating a sprayed waste material, the treated, non-asbestos product can be supplied in either the below described step of inputting a material or the step of supplying the material to a cement kiln after undergoing the above described acid treatment, as shown in FIG. 1, when fusion treatment is carried out in a fusion furnace, preferably in a cement kiln for a cement clinker sintering plant.

In particular, when a precipitate gained through the above described alkali treatment, concretely, the above described precipitate cake, is used as a material, it becomes possible to produce a cement clinker containing calcium fluoroaluminate.

Cement production can be roughly divided into the material preparation step, the sintering step, and the finishing step, which are described below in reference to FIG. 1.

The material preparation step can be divided into the material input step and the crushing and classification step.

In the material input step, first a main material for sintering a cement clinker, that is to say, limestone, is carried into and put in an input hopper 1 from outside the site, as well as clay, silica stone and an iron material.

In the case where the material is a large block, a crusher (not shown) is provided downstream from the input hopper 1, and the materials are crushed into pieces of a predetermined particle diameter, and after that stored in a material storehouse 2 by means of a transporter.

In the subsequent crushing and classification step in the material preparation step, the materials in the material storehouse 2 are mixed and crushed in a “material crusher” (material mill) and classified in a “classifier,” and thus, a stable powder material is prepared.

As the material crusher, a “vertical mill” 3 having three functions: drying, crushing and classifying into coarse powder and fine powder, is currently often used.

The thus gained powder material is mixed uniformly in a blending silo 4, for example, and after that introduced into a material storage silo 5.

In the method of treating an asbestos-containing waste material according to the present invention, the treated non-asbestos product after acid treatment is introduced into the input hopper 1 in the same manner as the other materials and stored separately as a material in the case where a sprayed waste material is treated, and may be introduced into the above described crusher 3 or introduced directly into the crusher 3 without being stored, or not introduced in the material preparation step.

Next, the powder material prepared through the above described material preparation step undergoes the sintering step.

In the sintering step, the powder material is heated to a predetermined temperature and sintered so as to have the water hardness properties of cement.

The sintering step is roughly divided into a supply step into a cement kiln, a sintering step, and a cooling step.

In the supply step into a cement kiln, first the powder material is put into a preheater 6 and heated, and then put in a rotary kiln 8.

The cement material put in the preheater 6 runs down through the preheater 6 while being heated to 800° C. to 900° C.

The cement material is heated in the preheater 6 while hot wind is sent into the preheater 6.

Here, many preheaters 6 are provided with a temporary burning furnace 7 in a lower portion.

In the sintering step, the cement material heated in the preheater 6 and sent into the rotary cement kiln 8 rotates two to three times per minute inside the rotary kiln 8 and moves toward the outlet while being sintered at a high temperature of approximately 1500° C., and then is converted to a sintered body (cement clinker) and taken out from the rotary kiln 8.

The cement material is sintered inside the rotary kiln 8 where fine charcoal powder is burnt when sent into the rotary kiln 8 in the direction of the rear of the rotary kiln 8 (side on which cement material put in) from the front (side from which sintered body taken out), and the temperature inside the rotary kiln 8 is approximately 1000° C. at the rear, approximately 1400° C. to 1500° C. at the spot where the temperature is highest, and approximately 1200° C. at the front.

Then, the sintered body taken out from the rotary kiln 8 is sent to the cooler 9.

In the cooling step, the sintered body taken out from the rotary kiln 8 is quenched through forceful cooling using air in the cooler 9 and sent to the finishing step.

In the method of treating an asbestos-containing waste material according to the present invention, the timing according to which the treated, non-asbestos product is supplied after acid treatment is unimportant, as long as fusion treatment can be carried out in the cement kiln, and it may be introduced into the preheater 6 after undergoing the material preparation step, introduced into the front of the rotary kiln 8 or introduced at the rear, as in the case of treatment of a sprayed waste material.

In addition, the treated material is supplied through the rear of the cement kiln in the case of treatment of a slate board.

As a result, the above described treated, detoxified product can be supplied to the cement kiln without being crushed from blocks, and even in the case where detoxification treatment through the above described acid treatment is not complete, asbestos can be prevented from dispersing and scattering when crushed, and furthermore, the treated, detoxified product remains in the kiln for a long period of time compared to in the case where it is supplied from the front of the kiln, and therefore, there is an advantage, such that fusion treatment is more complete.

As described above, the treated, non-asbestos material which is put in the rotary kiln together with the cement material after acid treatment rotates inside the rotary kiln while heating and fusing treatment is carried out for 20 minutes to 60 minutes at 1000° C. to 1500° C., for example.

At this time, it is preferable for the highest temperature to be 1450° C. or higher, and for the time for heating at a temperature of no lower than 1450° C. to be 5 minutes or longer.

The asbestos-containing waste material is fused and sintered, and forms a sintered body as s result of the above described heating treatment.

The conditions in terms of the temperature and time during the above described heating treatment are the same as the conditions for sintering general cement, and therefore, the waste material can be treated under the same conditions as when conventional cement is produced.

In addition, it is possible to add a flux when the above described fusion treatment is carried out if necessary.

As the flux, boric compounds, such as boric acid, borax, calcium borate and boronite calcite, phosphoric compounds, such as phosphoric acid, sodium phosphate and calcium phosphate, silicic compounds, such as silicic acid, sodium silicate and potassium silicate, carbonic compounds, such as sodium carbonate, potassium carbonate and lithium carbonate, barium compounds, such as barium carbonate and barium sulfate, and fluoric compounds, such as hydrogen fluoride and calcium fluoride, can be used.

In addition, it is desirable to add the flux agent during fusion treatment, because this makes fusion quicker and uniform, but this is not always necessary.

The flux functions to lower the melting point at the time of fusion and shorten the time for fusion.

Plaster is added to the thus gained cement clinker sintered body in order to adjust the time for cementation if necessary, and cement can be gained through the finishing step, in which the cement clinker sintered body is crushed using a finishing crusher (finishing mill).

Particularly in the case where an acid solution containing a compound including fluorine and a mineral acid is used for acid treatment, a cement clinker including calcium fluoroaluminate can be produced when a precipitate gained through the above described alkali treatment, concretely, precipitate cake made of calcium fluoride, is used as a material, and thus, it becomes possible to gain cement including calcium fluoroaluminate, such as jet cement.

Meanwhile, an asbestos-containing waste material containing asbestos and plaster, concretely, a treated, non-asbestos product gained by carrying out acid treatment on an asbestos-sprayed waste material containing asbestos and plaster, can be used as a plaster source for producing cement and mixed with the above described cement clinker (sintered body) in the above described finishing crusher in the cement finishing step.

Furthermore, treated, non-asbestos products gained by carrying out sulfuric acid treatment on a waste material containing asbestos and calcium where plaster is generated, as described above, and a treated, the non-asbestos product and plaster generated through the above described first to third acid treatment steps can be used as a plaster source at the time when cement is produced, and mixed together with the above described cement clinker (sintered body) in the above described finishing crusher in the cement finishing step, so that cement is produced.

As shown in FIG. 2, a cement clinker supplied from the cement clinker silo 1′ for storing a cement clinker is first crushed in a preparatory crusher 3′, for example.

The above described asbestos- and plaster-containing waste material which is treated and made non-asbestos and the above described asbestos- and calcium-containing waste material which is treated and made non-asbestos where a plaster is generated are stored in a plaster yard 2′ as a plaster source.

The thus crushed cement clinker, the above described asbestos- and plaster-containing treated, detoxified waste material supplied from the plaster yard 2′ are introduced into a cement crusher (finishing mill) 4′ and crushed and mixed.

The thus gained crushed mixture is introduced into a separator 5′, so that powder having a grain size in a desired range can be gained as Portland cement 7′.

In addition, the cement powder having a large particle size in the above described separator 5′ is again introduced into the crusher (finishing mill) 4′ and crushed.

Fly ash and a blast furnace slug powder are added to the cement powder, of which the grain size is adjusted to within a desired range using the separator 5′, and mixed uniformly in a mixer 6, so that a fly ash cement and a blast furnace cement 8′ can be prepared, if necessary.

Here, the above described treated non-asbestos product of an asbestos- and plaster-containing waste material and an asbestos- and calcium-containing waste material include plaster as an effective component and a non-asbestos product originating from asbestos as an impurity.

Meanwhile, the mixture ratio of the plaster in cement in the case where conventional Portland cement is produced is approximately 2 weight % to 3 weight %, for example, when calculated from SO3.

The cement gained according to the present invention has stable properties, and the gained cement has stable properties, and asbestos-sprayed waste materials can be completely and safely detoxified and reused.

### INDUSTRIAL APPLICABILITY

The method of treating an asbestos-containing waste material according to the present invention can be effectively applied for any waste material, such as slate boards and sprayed materials, irrespectively of the form of the asbestos-containing waste material.

In addition, it becomes possible to apply the method for producing a cement clinker or cement for the reuse of waste materials.

1. A method of treating an asbestos-containing waste material, comprising the steps of:
impregnating an asbestos containing waste material with an acid so as to cause the asbestos in said waste material to be non-asbestos, yielding a treated, non-asbestos product, and
further treating the treated non-asbestos product in a cement production plant.

2. The method of treating an asbestos-containing waste material according to claim 1, wherein the treatment in said cement production plant is fusion treatment using a cement kiln.

3. The method of treating an asbestos-containing waste material according to claim 2, wherein the asbestos-containing waste material is a slate board, said cement kiln is a rotary cement kiln, and said treated, non-asbestos product is supplied from a bottom of the rotary cement kiln.

4. The method of treating an asbestos-containing waste material according to claim 2, wherein said treated, non-asbestos product is supplied to the cement kiln without being crushed.

5. The method of treating an asbestos-containing waste material according to claim 1, further comprising the step of crushing and pulverizing the asbestos-containing waste material in an airtight state when the asbestos-containing waste material is impregnated with the acid.

6. The method of treating an asbestos-containing waste material according to claim 5, wherein said airtight state is a state wherein the asbestos-containing waste material is immersed in the acid.

7. The method of treating an asbestos-containing waste material according to claim 5, wherein
said airtight state is a state wherein the crushing and pulverizing is carried out using a crusher and pulverizer having an airtight case,
transportation from the crusher and pulverizer to an acid treatment container is conducted in an airtight case, and
the crushing and pulverizing step is carried out using an acid treatment container with an airtight case.

8. The method of treating an asbestos-containing waste material according to claim 1 wherein
said asbestos-containing waste material is an asbestos-sprayed waste material, and
the treatment in the cement production plant comprises the step of
supplying the treated, non-asbestos product in a step of putting a material in a cement clinker sintering plant, or
supplying the treated, non-asbestos product in a step of supplying a material to a cement kiln and carrying out the fusion treatment in the cement kiln.

9. The method of treating an asbestos-containing waste material according to claim 2, wherein
the acid is an acid solution comprising a compound including fluorine and a mineral acid,
the treated, non-asbestos product is a precipitate resulting from neutralization of the solution after asbestos treating the asbestos-containing waste material with alkali, and
the precipitate is used as a material for production of a cement clinker containing calcium fluoroaluminate, and
the fusion treatment is carried out in said cement kiln.

10. The method of treating an asbestos-containing waste material according to claim 9, wherein the precipitate comprises calcium fluoride, aluminum hydroxide, iron hydroxide, magnesium hydroxide and a silicate compound.

11. The method of treating an asbestos-containing waste material according to claim 2, wherein said treated, non-asbestos product is supplied to the cement kiln together with a flux.

12. The method of treating an asbestos-containing waste material according to claim 1, wherein said cement production plant is a crushing plant, and
further comprising a cement finishing step, wherein the treated, non-asbestos product is used as a plaster source.

13. The method of treating an asbestos-containing waste material according to claim 12, wherein said asbestos-containing waste material further comprises plaster.

14. The method of treating an asbestos-containing waste material according to claim 12, wherein
the asbestos-containing waste material comprises calcium,
the acid comprises sulfuric acid, and
the treated, non-asbestos product comprises a plaster resulting from a reaction between the calcium and the sulfuric acid.

15. The method of treating an asbestos-containing waste material according to claim 12, wherein the impregnating step comprises producing the treated, non-asbestos product in a solid form through
a first step of fusing the asbestos-containing waste material with a first acid to generate a water soluble salt through reaction with calcium or magnesium comprised in the asbestos-containing waste material,
a second step of depositing calcium sulfate by making liquid treated in the first step make contact with sulfuric acid, and
a third step of separating the treated, non-asbestos product in a solid form from the liquid treated in the second step.

16. The method of treating an asbestos-containing waste material according to claim 12, wherein said waste material is a sprayed material on rubble from a torn-down building.

17. The method of treating an asbestos-containing waste material according to claim 12, wherein the acid is one or more selected from the group consisting of phosphoric acid, sulfuric acid, nitric acid, hydrochloric acid and fluoric acid.

18. A treatment method of detoxifying an asbestos-containing waste material, which is the method of treating an asbestos-containing waste material according to claim 17, wherein the acid is an acid solution comprising:
at least one fluoride selected from the group consisting of fluorides of alkali metals, alkali earth metals and ammonium, and hydrofluoric acid, and
at least one mineral acid selected from the group consisting of hydrochloric acid, sulfuric acid and nitric acid,
and wherein a pH of the gained acid solution is 1 or less.

19. The treatment method of detoxifying an asbestos-containing waste material according to claim 18, wherein said acid solution comprises said at least one fluoride in an amount such that an ion concentration of the fluoride in the acid solution in a case where an entirety of a fluoride ion source is dissociated is 1.5 weight % to 10 weight %.

20. The treatment method of detoxifying an asbestos-containing waste material according to claim 18, wherein a weight ratio of the acid solution to the asbestos-containing waste material is 3 to 100.
